(19) United States
(12) Patent Application Publication
(10) Pub. No.: US 2002/0141624 A1
(43) Pub. Date: Oct. 3, 2002

(54) Apparatus and method for synchronizing images from an object undergoing cyclic variations

(75) Inventors: Amir Gil, Migdal Haemek Kiryat Tivon (IL); Tamir Gil, Doar Na Hefer (IL); Eli Horn, Kiryat Motzkin (IL); Yuval Garini, Doar Na Misgav (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: Applied Spectral Imaging Ltd.

(21) Appl. No.: 10/155,647

(22) Filed: May 28, 2002

Related U.S. Application Data
(63) Continuation-in-part of application No. PCT/IL00/00781, filed on Nov. 23, 2000.
(60) Provisional application No. 60/167,622, filed on Nov. 26, 1999.

(51) Int. Cl. G06K 9/00

(52) U.S. Cl. 382/128

(57) ABSTRACT

A synchronizing imaging apparatus to obtain images from an object undergoing variations according to a cycle with the apparatus comprising an acquisition device to acquire a plurality of pre-images at respective phases over each one of a plurality of cycles, and an image matcher to match together the pre-images from different ones of said cycles according to respective phases within said cycles, to create a representation of said cycle.

### RELATIONSHIP TO EXISTING APPLICATIONS

The present application is a continuation in part of PCT/IL00/00781 filed Nov. 23, 2000, which in turn claims priority from U.S. application Ser. No. 09/711,521, and from U.S. Provisional Application No. 60/167,622, filed Nov. 26, 1999.

### FIELD AND BACKGROUND OF THE INVENTION

The present invention relates to an apparatus and method for synchronizing images acquired from an object undergoing cyclic variations. More particularly, but not exclusively, the invention relates to synchronizing or matching images acquired from periodic cyclic variations exhibited in life sciences and more generally in physical phenomena as a whole.

Optical imaging of objects undergoing cyclical variations is challenging and may be more difficult when additional constraints exist. The need for additional image data (such as intensity or wavelength data) is an example of an additional constraint demanding additional image acquisition time. In parallel, the fact that an object is undergoing a cyclical variation constrains available time for image acquisition. The resultant need for multiple rapid image acquisitions yields a problem in low signal-to-noise ratio.

A possible way to solve such constraints would be to use more than one image acquisition system (for example, a camera with associated optics and electronics systems). This, however, would yield an expensive solution, necessitating a duplication of hardware. In addition, such a solution may not be feasible if there are space considerations precluding installation of multiple image acquisition systems.

### General Overview of Spectral Imaging

A useful example for describing an apparatus and method for synchronizing images acquired from an object undergoing cyclic variations is in the framework of spectral imaging. The field of optical imaging, including spectral imaging, can be divided into two major categories according to the wavelengths used: (i) optical imaging in the visual range; and (ii) optical imaging in the infrared range, typically the near infrared (NIR) range.

A spectrometer is an apparatus designed to accept light, to separate (disperse) it into its component wavelengths, and measure the spectrum thereof, that is the intensity of the light as a function of its wavelength. A spectral imaging device, also referred to herein as “imaging spectrometer”, is a spectrometer which collects incident light from a scene and measures the spectra of each picture element thereof.

Spectroscopy is a well known analytical tool which has been used for decades in science and industry to characterize materials and processes based on spectral signatures of chemical constituents therein. The physical basis of spectroscopy is the interaction of light with matter. Traditionally, spectroscopy is a measurement of the light intensity emitted, scattered, or reflected from or transmitted through a sample, as a function of wavelength, at high spectral resolution, but without any spatial information.

Spectral imaging, on the other hand, is a combination of high resolution spectroscopy and high resolution imaging (i.e., spatial information). Most of the work described to date in spectral imaging concerns either obtaining high spatial resolution information from a biological sample (yet providing only limited spectral information, for example, when high spatial resolution imaging is performed with one or several discrete band-pass filters) or obtaining high spectral resolution (e.g. full spectrum) with either limits in spatial resolution to a small number of points of the sample, or averaged over the entire sample. A reference regarding high spatial resolution is Andersson-Engels et al. (1990) Proceedings of SPIE—Bioimaging and Two-Dimensional Spectroscopy, 1205, pp. 179-189], whereas an example of limited spatial resolution is U.S. Pat. No. 4,930,516, to Alfano et al.

Conceptually, a spectral imaging system comprises a measurement system and analysis software. The measurement system includes all of the optics, electronics and the manner in which the sample is illuminated (e.g., light source selection), the mode of measurement (e.g., fluorescence or transmission), as well as the calibration best suited for extracting the desired results from the measurement. Analysis software includes all of the software and mathematical algorithms necessary to analyze and display results in a meaningful way.

Spectral imaging has been used for decades in the area of remote sensing to provide important insights in the study of Earth and other planets by identifying their characteristic spectral absorption features. However, the high cost, size and configuration of remote sensing spectral imaging systems (e.g., Landsat, AVIRIS) has limited their use to air and satellite-born applications [See, Maymon and Neeck (1988) Proceedings of SPIE—Recent Advances in Sensors, Radiometry and Data Processing for Remote Sensing, 924, pp. 10-22; Dozier (1988) Proceedings of SPIE—Recent Advances in Sensors, Radiometry and Data Processing for Remote Sensing, 924, pp. 23-30].

Among the many spectral imaging applications, spectral bio-imaging provides an example of a useful and developed application. There are three basic types of spectral dispersion methods that might be considered for a spectral bio-imaging system: (i) spectral grating or prism, (ii) interferometric spectroscopy, and (iii) spectral filters.

Spectral grating or prism spectroscopy may not be adaptable to acquiring useful image data from an object undergoing cyclic variations due to fact that most of the picture elements of one frame are not measured at any given time. The result is that either a relatively large measurement time is required to obtain the necessary information with a given signal-to-noise ratio, or the signal-to-noise ratio (sensitivity) is substantially reduced for a given measurement time.

Interferometric spectroscopy is a useful spectral bio-imaging method, however it also has limitations in applications involving image acquisition of an object undergoing cyclic variations. Image acquisition times using interferometric spectroscopy are typically not sufficiently short to enable a complete frame to be obtained in a reasonable time. As a result, similar to the case noted above with spectral grating or prism spectroscopy either a relatively large measurement time is required to obtain the necessary information with a given signal-to-noise ratio, or the signal-to-noise ratio (sensitivity) is substantially reduced for a given measurement time.

Spectral filter spectroscopy is a useful example in which the current embodiments may provide solutions by employing synchronization of multiple images from an object undergoing cyclic variations, as described below. Spectral dispersion filter-based methods can be categorized into discrete filter and tunable filter methods. In these types of imaging spectrometers the spectral image is built by filtering the radiation for all the picture elements of the scene simultaneously at a different wavelength, one at a time, by successively inserting narrow band pass filters in the optical path, or by electronically scanning the bands using acousto-optic tunable filters (AOTF) or liquid-crystal tunable filters (LCTF). In filter-based spectral dispersion methods, most of the radiation at any given time is rejected. In fact, measurement of the entire image at a specific wavelength takes place as all photons outside the instantaneous wavelength being measured are rejected and, as a result, do not reach the CCD.

Tunable filters, such as AOTFs and LCTFs have no moving parts and can be tuned to any particular wavelength in the spectral range of the device in which they are implemented. One advantage of using tunable filters as a dispersion method for spectral imaging is their random wavelength access; i.e., the ability to measure the intensity of an image at a number of wavelengths, in any desired sequence without the use of filter wheels. However, AOTFs and LCTFs have the disadvantages of (i) limited spectral range (typically, λₘₐₓ=2 λₘᵢₙ) while all other radiation outside of this spectral range must be blocked, (ii) temperature sensitivity, (iii) poor transmission, (iv) polarization sensitivity, and, in the case of AOTFs, (v) an effect of shifting the image during wavelength scanning, demanding subsequent careful and complicated registration procedures. Tunable filter-based systems have not been used successfully and extensively over the years in spectral imaging for any application because of their limitations in spectral resolution, low sensitivity, and lack of sophisticated software algorithms for interpretation and display of the data. Discrete filter-based systems have similarly not been used extensively for similar reasons.

Essentially, the need to acquire multiple images of the same object at different wavelengths, using filters in succession, has presented a heretofore-insurmountable challenge in applying filter-based spectral imaging. Problems associated with acquiring images of an object undergoing a cyclic movement may be divided into two groups:

1. Problems of image movement (spatial movement). Numerous algorithms and methods exist for image registration s of a moving object. However, movements associated with biological phenomenon exhibit the most complex types of movement, including translation, rotation, and non-homogenous image stretching around a point which may or may not be included in the image. Correcting for these types of movements to sub-pixel registration level (a requirement in many applications) is not impossible, but such correction involves extensive resources and time consuming calculations.

2. Problems of intensity changes caused by the spatial movement of the object. Consider the illumination of a complex object such as, but not limited to, a portion of the human cortex made visible during neurosurgery. The surface of this object is highly irregular, curved, and lies within a deep cavity. Achieving homogenous illumination of such an object is an almost impossible task, further compounded when attempting to quickly position an imaging system., A cortex area moving with brain pulsation exhibits intensity changes which are a result of changes in the angle between an illumination module, a cortex element, and collecting optics. To complicate the problem further, different cortical areas will experience different intensity changes as a result of cortex movement. The magnitude of these intensity changes is about 1% of the overall intensity, as can be seen when looking at a registrated intensity recording (through a narrow band pass filter) of a human cortex. The following two figures further amplify this point.

Reference is made to FIG. 1, which shows part of a human cortex exposed during neurosurgery. Colors used in FIG. 1 are artificially intensity-coded, with blue indicating lower intensity and red higher intensity. The location 2 of the cortex area from which the data was taken is indicated as a small, intense blue region.

Reference is now made to FIG. 2, which is a graph showing a monochrome, 610 nm filter with full width at half maximum (FWHM) of 10 nm, 2.5 minute recording of a human cortex, obtained at the location 2 indicated in FIG. 1. In the present figure, approximately 220 frames are shown, with normalized reflectance values ranging from about 0.84 to about 0.96. Three peaks 4 indicated in the graph are intentional markings made to indicate certain events during the recording. The smaller intensity fluctuations 6, demonstrate intensity changes resulting from cortex movement with blood flow. Intensity fluctuations such as indicated in the present figure are typically acquired from spectral images and correlated with blood oxygen saturation fluctuations—a useful metric in neurosurgery. Although the data shown is considered a good recording, the level of noise exhibited may ultimately introduce substantial noise into a spectral image, as described below. The amount of noise in results for calculating oxygen saturation following a 1% random noise in input data is of a standard deviation of 4%, making it impossible to detect oxygen changes smaller than 4% with confidence.

The overall problem has been in obtaining a sufficient signal for individual images. Once the problem of obtaining sufficient signal for an image at a given wavelength has been solved then the resultant technique may be extended to multiple wavelengths.

For example, if one wanted to obtain spectral images of a part of the human body undergoing changes related to heartbeat, a basic imaging scheme would include heart beat synchronization so that spectral filters were changed according to the heartbeat. The final result in this case would be that all acquired frames (meaning all single acquisitions through a single filter) were of the part of the human body at the same phase of the heartbeat. Construction of such a spectral filter scan in this example is relatively straightforward. The major drawback, however, is that it is time consuming. A single scan (of 10 filters, a typical number) would take 5-10 seconds (with typical heartbeat rates ranging from 60-120 beats/minute). Should one wish to perform three scans, for better S/N discrimination, total acquisition time could be as much as 30 seconds—an unacceptable amount of time in most applications. Therefore the question of how to sample with a filter system is non trivial.

### SUMMARY OF THE INVENTION

According to a first aspect of the present invention there is thus provided an apparatus for synchronizing imaging apparatus to obtain images from an object undergoing variations according to a cycle, the apparatus comprising:

an acquisition device to acquire a plurality of pre-images at respective phases over each one of a plurality of cycles, and

an image matcher to match together said pre-images from different ones of said cycles according to respective phases within said cycles, thereby to create a representation of said cycle.

Preferably said acquisition device comprises at least one lens and at least one interference filter associated therewith, said lens and said interference filter both being positioned before a light intensity recording device.

Preferably said acquisition device further comprises at least one fore-optics lens positioned before said interference filter, said interference filter positioned before at least one post-optics lens, which in turn is positioned before said light intensity recording device.

Preferably said interference filter comprises a plurality of filters, each set to a respective predetermined wavelength range.

Preferably said light intensity recording device is a CCD device.

Preferably said filters are arrayed on a filter wheel controllably rotatable about its axis to selected positions to allow said filters to be individually positioned between said fore optics lens and said post optics lens.

Preferably further comprising a filter wheel coordinator controllably associated with said filter wheel to controllably position said filter wheel in coordination with pre-image acquisition.

Preferably said filter wheel coordinator comprises a processor.

Preferably said filter wheel coordinator is operable to iteratively advance said filter wheel to in coordination with acquisition of pre-images using successive filters such that a plurality of pre-images are acquired with each of said filters.

Preferably said filter wheel coordinator is operable to advance said filter wheel in a substantially continuous movement so that successive pre-images are acquired using successive ones of said filters.

Preferably said substantially continuous movement allows for pre-images to be acquired for at least one rotation of said filter wheel.

Preferably said representation is a spectral representation.

Preferably said image matcher comprises:

a cycle phase detector to determine pre-image phase position in respective cycles, and

image storage to store pre-images, filter information, and representations.

Preferably said cycle phase detector is operable to compare one pre-image to another pre-image and, based on at least one matching criterion, to match said pre-image with at least another pre-image.

Preferably said matching criteria is at least one selected from a list comprising: intensity, contrast, size, and color.

Preferably a variation sensing device is operable to identify at least one phase within respective cycles.

Preferably said variation sensing device is operable to control pre-image acquisitions so that a plurality of pre-images are acquired upon at least one substantially identical phase of respective cycles.

Preferably said image matcher is operable to match pre-images according to the phase at which pre-images were acquired and to further group said pre-images according to a respective filter used.

Preferably said cycle is the human heartbeat.

Preferably said variation sensing device comprises a cardiac gating device.

Preferably said cardiac gating device is an ECG which is operable to output a signal whenever an R wave is detected.

Preferably said object is the exposed cortex of a human brain.

According to a second aspect of the present invention there is thus provided a method of obtaining pre-images from an object undergoing variations according to a cycle and to create full spectral images therefrom, comprising the steps of:

acquiring a plurality of filtered pre-images in respective cycles using at least one filter;

storing said pre-images; and

matching pre-images from step ii according to substantially respective cycle phases to form said full spectral images.

Preferably said acquiring of pre-images comprises the process of:

selectively positioning a filter to filter a respective pre-image;

acquiring a plurality of pre-images;

positioning another filter; and

repeating steps ii and iii and until acquisitions have been performed with each of a predetermined set of said filters.

Preferably said storing of pre-images further comprises storing a respective filter identity representing said filter used to acquire said respective pre-image, and wherein said matching additionally uses said respective filter identity.

Preferably said matching of pre-images comprises:

comparing a present pre-image to at least one other pre-image to substantially match said present pre-image with at least one other pre-image, according to predetermined criteria chosen from a group consisting of contrast, intensity, and color;

grouping said matched present pre-image with matches of other ones of pre-images; and

ordering said grouped, matched pre-images according to respective filter information.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 shows part of a human cortex exposed during neurosurgery, in accordance with prior art;

FIG. 2 is a graph showing a monochrome, 610 nm filter with full width at half maximum (FWHM) of 10 nm, 2.5 minute recording of a human cortex, obtained at the location 2 indicated in FIG. 1;

FIG. 3 is a simplified block diagram of the synchronizing apparatus for matching and synchronizing images acquired from an object undergoing cyclic variations in accordance with a first preferred embodiment of the present invention;

FIG. 4 is schematic diagram of a discrete filter-based spectral imaging device in accordance with a second preferred embodiment of the present invention;

FIG. 5 is a simplified waveform diagram showing timings of image acquisition for image matching in accordance with the embodiment of FIG. 4;

FIG. 6 is a simplified block diagram of a synchronizing apparatus for matching and synchronizing images acquired from an object undergoing cyclic variations, including variation sensing feedback, in accordance with a fourth preferred embodiment of the present invention; and

FIG. 7 is a simplified waveform diagram showing timings of image acquisition using matching and variation sensing in accordance with the embodiment of FIG. 6.

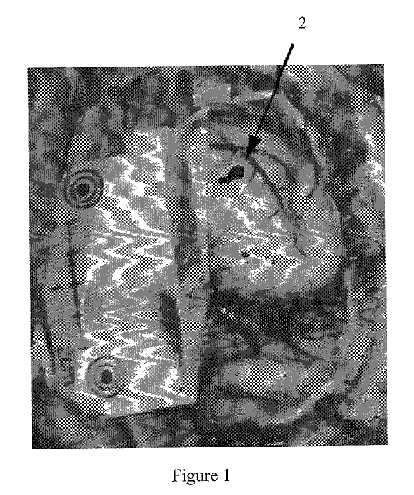

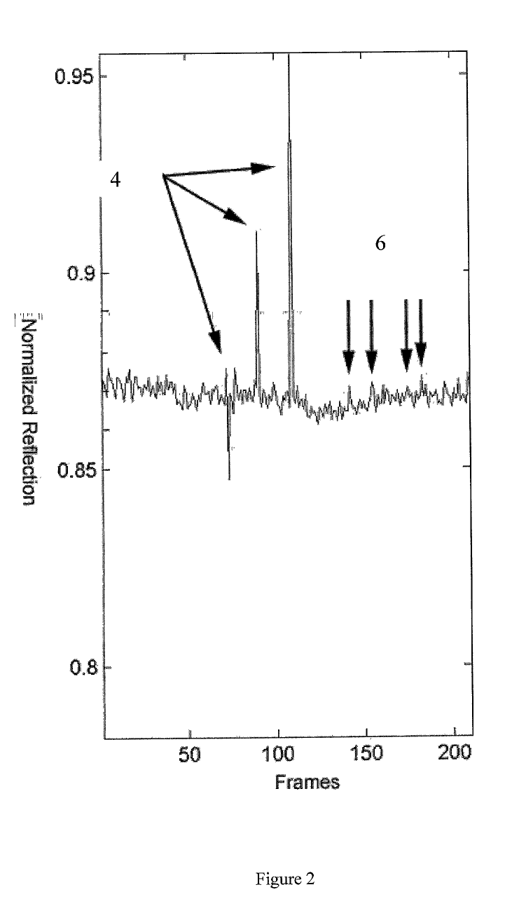

### DESCRIPTION OF THE PREFERRED EMBODIMENTS

The present embodiments comprise an apparatus or method for synchronizing images from an object undergoing cyclic variations. Preferred embodiments of the present invention include:

a. Acquisition of multiple images of an object undergoing cyclic variations and, using image processing techniques, matching images from identical phases of a repetitive cycle;

b. Using a variation sensing device to control the acquisition timing of images of an object undergoing cyclic variations, so that successive images are acquired at identical phases in a repetitive cycle, to enable matching.

The present embodiments address the above-mentioned constraints by acquiring many images of an object, using one image acquisition system over several cycles and then by matching the images so that data obtained from different cycles are aggregated together. Matching of acquired images, according to their specific phase in the variation cycle, through the use of an image matching apparatus or method, is described below. The embodiments thereby effectively increase the signal-to-noise ratio of images.

Before explaining the embodiments of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

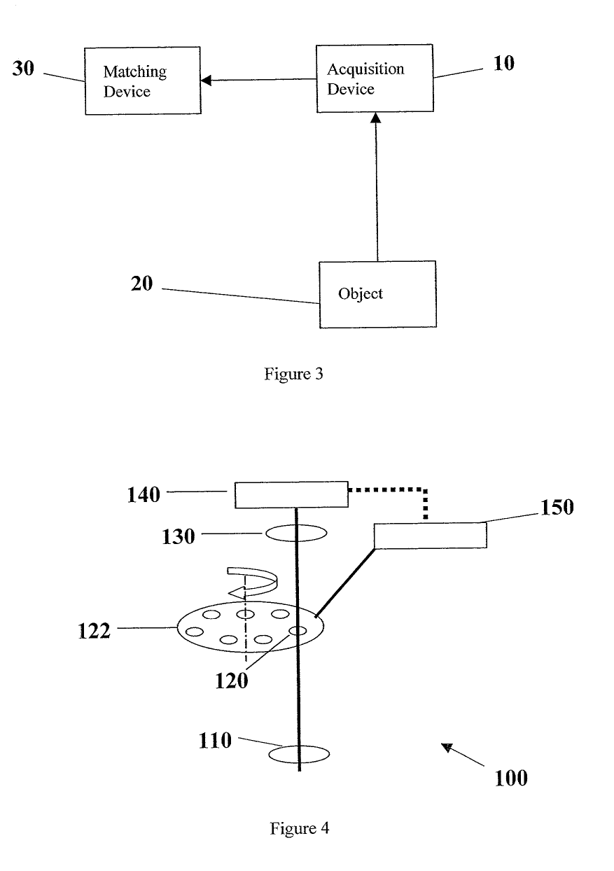

Reference is now made to FIG. 3 which is general block diagram of a synchronizing apparatus according to a first preferred embodiment of the present invention. An acquisition device 10 acquires images from an object 20. Images acquired by the acquisition device 10 are transferred to a matching device 30, which matches images according to their apparent phases in a cyclic variation. The matching device 30 preferably comprises an image processor and storage, with or without an adjoining display unit.

Matching an image according to its apparent phase in a cyclic variation sequence can be performed in two ways. One way is to match an image by employing an image processor to compare image characteristics indicative of a specific phase of the cyclical variation in acquired images. Thus, for example, image intensity or color intensity of all or a portion of an image may be followed and changes therein may be used by an image processor to match uniphase images (i.e. images of the same phase of repeating cycles.)

Another method is to acquire images with the assistance of a cycle-synchronization device, such as a waveform tracking device as described further below, so that a corresponding phase of the cycle can be recorded with each image. Images may then be grouped together according to the recorded phase information.

It may be appreciated that the block diagram logic of FIG. 3 applies equally to large, long range imaging systems, such as in spacecraft-borne imaging or airborne imaging systems, and to compact, stationary imaging systems such as bio-imaging or electronic-component imaging systems.

By way of example only, one application of the present invention is in the field of discrete filter-based spectral imaging. Reference is now made to FIG. 4 which is a simplified schematic representation of a discrete filter-based spectral imaging device, according to a second embodiment of the present invention. A filter-based spectral imaging device apparatus 100 is shown. An objective 110 directs light through an interference filter 120 located in an interference filter wheel 122, through post optics 130 and to a light intensity measurement device 140. The interference filter wheel 122 is controlled by a filter selector 150. The filter selector 150 coordinates acquisition of images with the light intensity measurement device 140. Note, solely for illustration purposes, the number of filters shown in the interference filter wheel 122 is seven. More or fewer filters may be located in the filter wheel as appropriate to the specific application and the wavelengths of interest.

Note that rotation of the interference filter wheel 122 enables individual discrete filters to be used for successive filter scans (combination of multiple image acquisitions using a given filter) by the light intensity measurement device 140, typically a CCD. The interference filter wheel 122 may be driven by a controllable DC motor. After the interference filter wheel 122 is positioned for a specific interference filter 120, an acquisition takes place for a finite time, typically from 20-100 milliseconds. Additional images may be acquired with the present interference filter 120, or the interference filter wheel 122 may be advanced to another interference filter 120 position for acquisition of further images. The image acquisition process is continued until both a sufficient number of interference filters have been used (representing full coverage of the spectrum of interest for spectral imaging of the object) and a sufficient number of images have been acquired from repetitive cycles. At this point, filter scans are combined to construct a complete spectral image, as discussed further below.

The apparatus indicated in FIG. 4 may be used with a specific cyclic variation application, such as image acquisition using multiple filters synchronized with heart rate. A typical heart rate ranges from 60-120 beats per minute, yielding a typical period (one heart beat) of 0.5 to one second. A typical number of interference filters used for a filter scan may be 10. Assuming one image acquisition per heartbeat is obtained, a one-image acquisition filter scan using the typical number of 10 filters would therefore take 5-10 seconds. Should one wish to perform more than one filter scan (it is typical to acquire a minimum of 3 images per filter to improve signal to noise quality) total acquisition time may take up to 30 seconds—an unacceptably long time.

As a result, there is a need for higher speed filter scanning and for more flexible and faster methods to synchronize images. The filters and wheel mechanisms noted in FIG. 4 are typically capable of replacing up to 60 filters per second, allowing completion of up to 6 filter image acquisitions per second. The following discusses details and considerations for applying such an apparatus.

Heart Rate Synchronization with Multiple Sampling Through Each Filter

A specific example of image acquisition related to heart rate is in functional brain mapping where a human cortex is viewed during neurosurgery. A portion of the cortex is exposed and functional brain mapping is performed using cortex spectral images acquired before and after brain stimulation. Additional analysis and indication of functional brain regions in the exposed brain tissue can be gained from oxygen saturation differences in the tissue—acquired from spectral images. Therefore a technique that enables synchronizing images to compare images acquired from nearly identical phases during heartbeat is very useful.

Using the following notation:

N—the number of filters used to construct a filter scan (filters are denoted F₁, . . . , F_{N});

T—the heart rate period time (=1/heart rate) in seconds;

t—the CCD acquisition time through each filter; (The same acquisition time is used for all filters (typically 20-100 ms.)

ST—the filter switching time, the time it takes to switch from one filter to the following filter; and

n—the number of individual image acquisitions performed through a single filter during one cycle period, defined as the largest integer n such that n*t≦T−ST (these are denoted e₁, . . . eₙ),

a model for calculations is presented below.

n image acquisitions are collected during each heart beat followed by a switch to another filter. Filter scans can be built in two ways, noted as: “along” and “across” as described below.

In the “along” method, the first images from all N filters (F₁e₁, F₂e₁, . . . ,F_{N}e₁) are collected to construct a uniphase filter scan. Eventually n uniphase filter scans are produced, each representing a different phase of the heart rate period, covering all the filters. A desired calculation is applied to each of the n filter scans.

In the “across” method the n image acquisitions for each filter (F₁e₁,F₁e₂ . . . ,F₁eₙ) are aligned and averaged, producing a value that is denoted F₁ (and F₂, . . . ,F_{N}). The N F values are used to construct uniphase filter scans for all of the filters.

Using the “along” method from above as an example, one way to synchronize images (i.e. to group uniphase images) is to acquire images with a given filter, and using image processing, determine which images are uniphase. Image processing can key in upon image characteristics such as intensity, shape, contrast, or particular color levels, which are characteristic of the same phase in a cyclic variation. Image processing can be used to rapidly construct uniphase filter scans, from image acquisitions identified to be uniphase, in real-time or near real-time conditions.

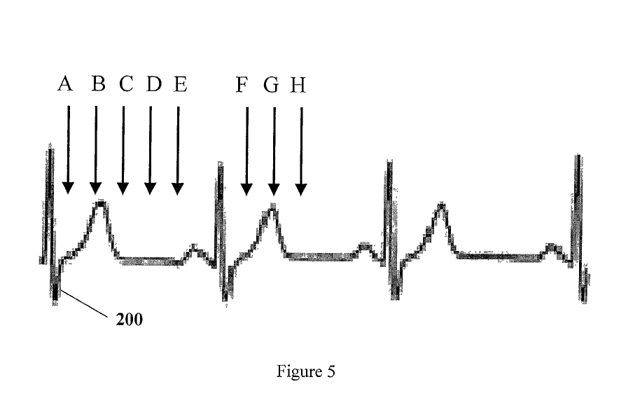

To further amplify this point, reference is now made to FIG. 5 which is a simplified waveform diagram showing timings of image acquisition for image matching, according to an application of the apparatus shown in FIG. 4 above. The waveform 200 represents a cyclic variation signal, in this case, a representation of a heart rate plotted against time. Image acquisition timings ABCDEFGH are made of a part of the human body where cyclic blood flow changes in images are of interest, such as, for example, in functional monitoring of the cortex of a human brain in vitro. Images are acquired at a sufficiently fast rate to allow many more than one image to be acquired per heart beat period. For simplicity, we assume in this discussion that only one filter (of a total of N filters) is being used to acquire images ABCDEFGH.

Taking the images from the timings ABCDEFGH indicated in the current figure and using image processing to compare the acquired images, images acquired at timings B and G may be identified as uniphase images, and thus combined together into a single filter scan part. In a similar fashion, images from timings C and H would also be considered uniphase images, and thus taken together to form another part of the current filter scan. It can be appreciated that if additional images were acquired in additional cycles of the waveform 200 of the current figure, a set of perhaps 4 or 5 uniphase images using the current filter could be grouped, thus creating a complete filter scan for the first of N filters. According to the “along” method, a new filter is positioned and another group of image acquisitions is performed, followed by image processing and creation of another complete filter scan of uniphase images.

The “across” method is applied in analogous fashion to FIG. 5, where the timings ABCDEFGH represent successive acquisitions, each using a successive filter on the filter wheel. Uniphase images are matched using image processing in an analogous fashion as described above but this time, filter scans are constructed in parallel as more and more images are acquired using different filters at different phases. In both “across” and “along” cases, it should be emphasized that many more images than indicated in FIG. 3 would have to be acquired to complete a set of filter scans.

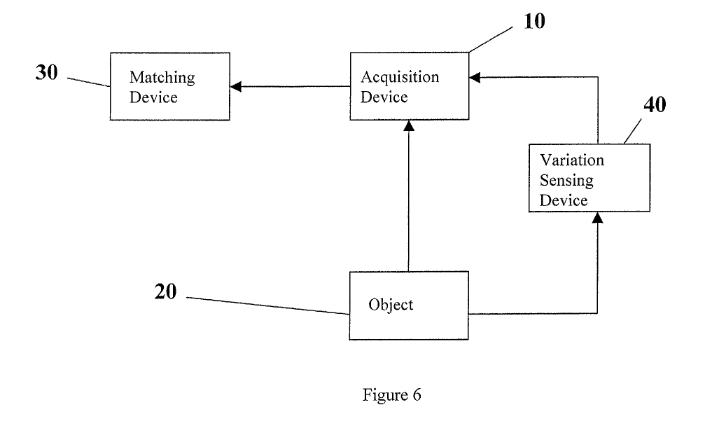

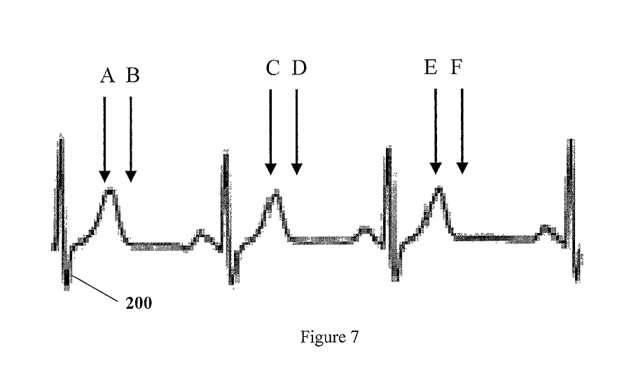

Another apparatus for synchronizing images is shown in FIG. 6, which is a block diagram of a synchronizing apparatus with variation sensing feedback, according to a third preferred embodiment of the present invention. The block diagram of FIG. 6 is similar to that shown previously in FIG. 3. A variation sensing device 40 is added, however, to yield a direct or indirect indication of a given phase in the cycle, for example the beginning, end, maximum amplitude, minimum amplitude, etc. The variation sensing device 40 provides control, determining when the acquisition device acquires an image. Images are therefore acquired according to a specific occurrence, or phase, within the cycle. As a result, synchronization of images is achieved by timing of acquisition. Matching is then carried out between corresponding synchronized images, as they are acquired, stored, and reordered. In parallel, an indication produced by the sensing device is preferably recorded in association with a respective image.

Reference is now made to FIG. 7, which is a simplified waveform diagram showing controlled timings of image acquisitions, as previously referred to in the block diagram of FIG. 6. A waveform 200 represents a cyclic variation signal, in this case, a representation of a heart rate plotted against time. Images ABCDEF are acquired at controlled instances within each cyclic variation. For example, cardiac gating devices (as used in some MRI's and nuclear medicine imagers) may be used to control acquisition timing. An example of such a cardiac gating device is an ECG, which outputs a signal whenever an R wave (for example) is detected. This signal is used to trigger the CCD and cause an image to be acquired.

It should be noted that while image processing may not actively be needed to determine uniphase images according to this embodiment, images acquired still need to be stored and organized. Image processing may be employed to sample and verify uniphase images and to flag the need for additional acquisitions, should previous acquisitions not be suitably matched.

Controlled timing of acquisitions in the present embodiment is used directly to build uniphase filter scans in a method similar to that discussed for FIG. 5, namely “across” or “along”. In both cases, applying the specific heart rate example, the final result is a complete filter scan representing perhaps 4 or 5 uniphase images for each of the N filters used.

Once obtained, the resultant 4-5 uniphase images may be used to create one image for presentation to a doctor or a technician. One way to accomplish this is not to perform any image processing and to use one of the uniphase images, as is, as a final image for the doctor or technician. However, averaging the resultant 4-5 uniphase images can greatly improve the signal-to-noise ratio of the data. It should be noted that due to the way uniphase images are created using the previously discussed “along” or “across” methods, averaging resultant images to create one final image will yield different signal-to-noise ratios, based on the respective “along” or “across” method used.

It is appreciated that the periodic cyclic variations noted in the present invention may represent any one of many periodic cyclic variations exhibited not only in life sciences, but also in a multitude of other physical phenomena.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub combination.

It will be appreciated by persons skilled in the art that the present invention is not limited to what has been particularly shown and described hereinabove. Rather the scope of the present invention is defined by the appended claims and includes both combinations and sub combinations of the various features described hereinabove as well as variations and modifications thereof which would occur to persons skilled in the art upon reading the foregoing description.

1. A synchronizing imaging apparatus to obtain images from an object undergoing variations according to a cycle, the apparatus comprising:
i. an acquisition device to acquire a plurality of pre-images at respective phases over each one of a plurality of cycles, and
ii. an image matcher to match together said pre-images from different ones of said cycles according to respective phases within said cycles, thereby to create a representation of said cycle.

2. An apparatus according to claim 1 wherein said acquisition device comprises at least one lens and at least one interference filter associated therewith, said lens and said interference filter both being positioned before a light intensity recording device.

3. An apparatus according to claim 2 wherein said acquisition device further comprises at least one fore-optics lens positioned before said interference filter, said interference filter positioned before at least one post-optics lens, which in turn is positioned before said light intensity recording device.

4. An apparatus according to claim 2 wherein said interference filter comprises a plurality of filters, each set to a respective predetermined wavelength range.

5. An apparatus according to claim 2 wherein said light intensity recording device is a CCD device.

6. An apparatus according to claim 4 wherein said filters are arrayed on a filter wheel controllably rotatable about its axis to selected positions to allow said filters to be individually positioned between said fore optics lens and said post optics lens.

7. An apparatus according to claim 6 further comprising a filter wheel coordinator controllably associated with said filter wheel to controllably position said filter wheel in coordination with pre-image acquisition.

8. An apparatus according to claim 7 wherein said filter wheel coordinator comprises a processor.

9. An apparatus according to claim 7 wherein said filter wheel coordinator is operable to iteratively advance said filter wheel to in coordination with acquisition of pre-images using successive filters such that a plurality of pre-images are acquired with each of said filters.

10. An apparatus according to claim 7 wherein said filter wheel coordinator is operable to advance said filter wheel in a substantially continuous movement so that successive pre-images are acquired using successive ones of said filters.

11. An apparatus according to claim 10 wherein said substantially continuous movement allows for pre-images to be acquired for at least one rotation of said filter wheel.

12. An apparatus according to claim 1 wherein said representation is a spectral representation.

13. An apparatus according to claim 2 wherein said image matcher comprises:
i. a cycle phase detector to determine pre-image phase position in respective cycles, and
ii. image storage to store pre-images, filter information, and representations.

14. An apparatus according to claim 13 wherein said cycle phase detector is operable to compare one pre-image to another pre-image and, based on at least one matching criterion, to match said pre-image with at least another pre-image.

15. An apparatus according to claim 14 wherein said matching criteria is at least one selected from a list comprising: intensity, contrast, size, and color.

16. An apparatus according to claim 1 wherein a variation sensing device is operable to identify at least one phase within respective cycles.

17. An apparatus according to claim 16 wherein said variation sensing device is operable to control pre-image acquisitions so that a plurality of pre-images are acquired upon at least one substantially identical phase of respective cycles.

18. An apparatus according to claim 17 wherein said image matcher is operable to match pre-images according to the phase at which pre-images were acquired and to further group said pre-images according to a respective filter used.

19. An apparatus according to claim 1 wherein said cycle is the human heartbeat.

20. An apparatus according to claim 17 wherein said variation sensing device comprises a cardiac gating device.

21. An apparatus according to claim 20 wherein said cardiac gating device is an ECG which is operable to output a signal whenever an R wave is detected.

22. An apparatus according to claim 1 wherein said object is the exposed cortex of a human brain.

23. A method of obtaining pre-images from an object undergoing variations according to a cycle and to create full spectral images therefrom, comprising the steps of:
i. acquiring a plurality of filtered pre-images in respective cycles using at least one filter;
ii. storing said pre-inages; and
iii. matching pre-images from step ii according to substantially respective cycle phases to form said full spectral images.

24. A method according to claim 23 wherein said acquiring of pre-images comprises the process of:
i. selectively positioning a filter to filter a respective pre-image;
ii. acquiring a plurality of pre-images;
iii. positioning another filter; and
iv. repeating steps ii and iii and until acquisitions have been performed with each of a predetermined set of said filters.

25. A method according to claim 23 wherein said storing of pre-images further comprises storing a respective filter identity representing said filter used to acquire said respective pre-image, and wherein said matching additionally uses said respective filter identity.

26. A method according to claim 23 wherein said matching of pre-images comprises:
i. comparing a present pre-image to at least one other pre-image to substantially match said present pre-image with at least one other pre-image, according to predetermined criteria chosen from a group consisting of contrast, intensity, and color;
ii. grouping said matched present pre-image with matches of other ones of pre-images; and
iii. ordering said grouped, matched pre-images according to respective filter information.
